(19) United States
(12) Patent Application Publication
(10) Pub. No.: US 2005/0000368 A1
(43) Pub. Date: Jan. 6, 2005

(54) Smokeless grill set

(76) Inventors: Jeff Siegel, Kings Point, NY (US); Adam Krent, Brooklyn, NY (US)

Correspondence Address: GOODMAN & TEITELBAUM, SUITE 1400, 26 COURT STREET, BROOKLYN, NY, 11242, US

(21) Appl. No.: 10/834,340

(22) Filed: Apr. 28, 2004

Related U.S. Application Data
(60) Provisional application No. 60/467,444, filed on May 2, 2003.

(51) Int. Cl. F24C 5/20; A47J 37/00

(52) U.S. Cl. 99/400; 99/446; 126/41 R

(57) ABSTRACT

A smokeless grill assembly or kit includes a grill stand supporting a grill pan. A grill support spans said grill pan and supports a grill top above a burner unit supported in the grill stand. A handle extends from the burner unit and allows easy removal and replacement and the ability to manipulate at least one combustion regulation mechanism. A diverting mechanism diverts dripping oil from an inner heated region of the grill top to a peripheral region reducing an oil temperature below a smoke point.

### PRIORITY CLAIM

This application claims priority from Provisional Application Ser. No. 60/467,444, filed on May 2, 2003, the contents of which are incorporated by reference.

### BACKGROUND OF THE INVENTION

1. Field of the Invention

The present invention relates to a smokeless grill set. More specifically, it relates to a smokeless grill set that diverts oils from an inner heated region to a cooler peripheral region remote from the inner region so that the hot oil does not smoke.

2. Description of the Related Art

It is conventionally known to grill items on a sloped flat surface. The most common example of this type of conventional grill is the George Foreman Grill advertised on television. This type of conventional grill includes a surface sloped along a single plane as well as protuberances on the grill surface to suspend the grilled food and allow grease to drip and run along the heated sloped surface to a cooler catch zone. The catch zone typically lies in a channel aligned with the single plane of the sloped surface.

As show in U.S. Pat. No. 5,191,831 to Walden, an oven includes an annular water ring assembly and a centrally located catch surface over a centrally located heating unit. A set of racks positioned above the catch surface suspend items being smoked or grilled. The catch surface diverts the upwardly rising heat to provide a more uniform heating in the oven.

As shown in U.S. Pat. No. 4,694,816 to Fabbro, an annular trough that is filled with water and positioned outward from a stove-based direct heat source. A lid covers the grill and water trough. The grill includes grilling positions directly above the water trough and an open central aperture permits upwardly rising heat to reach the lid and be circulated downwardly to cook food items from both sides. The grill is open and directs dripping oils directly downward into the water trough without outward movement.

Another conventional design is shown in U.S. Pat. No. D327,807 to Jung. Jung discloses a smokeless grill member that appears to have a convex heating plate and an annular trough for collection. The grill, as a unit, is positioned over a heat source and food items for grilling are positioned on the grilling surface. Holes in the grilling surface are positioned directly below the items being grilled and appear capable of dripping oil onto the heat source positioned below the grill.

### OBJECTS AND SUMMARY OF THE INVENTION

An object of the present invention is to provide an alternative design that overcomes the disadvantages noted above.

One embodiment of the present invention provides a smokeless grill assembly having a grill stand supporting a grill pan member. A grill support spans the grill pan member and supports a sloped grill top member. A burner unit support (in the grill stand) supports a removable burner unit in a generally central position of both the grill top and the grill pan. A handle extends from the burner unit and allows easy transport of the burner unit. A slidable cover is positioned to slidably close the burner unit. The grill assembly includes a means to divert dripping oil from an inner heated region of the grill top to a cooler peripheral region. An optional plurality of embossed portions support grilled food items above the grill top. An alternative peripheral receiving collector receives oil diverted from the heated region.

According to another embodiment of the present invention, there is provided a smokeless grilling kit, comprising: a grill pan member supporting a removable grill top member, the grill top member including a grilling surface for grilling external food items, means for producing thermal energy and for directing the thermal energy upwardly toward the grilling surface, a support stand member supporting the grill pan member above the means for producing thermal energy and spacing the grill pan member from an external support surface, and means for diverting grilling oils laterally away from an inner hotter region of the grilling surface to a cooler peripheral region remote from the inner hotter region, whereby the oil is cooled and does not smoke during a grilling use.

According to another embodiment of the present invention, there is provided a smokeless grilling kit, further comprising: a means for receiving the grilling oils from the means for diverting during the use and for storing the oils in a position remote from the inner hotter region, whereby the oils are additionally cooled and easily contained during the use enabling a safe and a convenient user disposal.

According to another embodiment of the present invention, there is provided a smokeless grilling kit, further comprising: a plurality of embossed portions on the grilling surface, and the embossed portions spacing portions of the grilling food items from the grilling surface, thereby enabling the grilling oils to be more easily diverted laterally from the inner hotter region to the cooler peripheral region by the means for diverting.

According to another embodiment of the present invention, there is provided a smokeless grilling kit, further comprising: a plurality of holes spaced about the grill top member.

According to another embodiment of the present invention, there is provided a smokeless grilling kit, wherein: the plurality of holes are spaced about the peripheral region of the grilling surface distal from the hotter inner region, whereby the holes enable portions of the grilling oils to pass through ones of the plurality of holes and fall into the means for receiving.

According to another embodiment of the present invention, there is provided a smokeless grilling kit, wherein: each hole is positioned proximate respective outward ends of the embossed portions, whereby the embossed portions aid in guiding the grilling oils into holes.

According to another embodiment of the present invention, there is provided a smokeless grilling kit, wherein: the support stand member further comprises: means for centrally locating the means for producing thermal energy relative to the grill pan member and grill top members, whereby during the use the thermal energy is produced proximate the central hotter region of the grill top member.

According to another embodiment of the present invention, there is provided a smokeless grilling kit, wherein: the grill pan member includes a centrally positioned opening between the means for producing thermal energy and the grilling surface.

According to another embodiment of the present invention, there is provided a smokeless grilling kit, further comprising: a grill support member, and the grill support member spanning a portion of the grill pan member and supporting the grill top member relative to the grill pan member, whereby the grill top member is spaced from the grill pan member.

According to another embodiment of the present invention, there is provided a smokeless grilling kit, further comprising: a non-stick coating on at least one of the grilling surface, the grill pan member, and the means for diverting grilling oils, whereby the non-stick coating improves a transport of the grilling oils during the use and eases clean up after the use.

According to another embodiment of the present invention, there is provided a smokeless grilling kit, further comprising: a burner support sub-assembly in the support stand, and the burner support sub-assembly positionably supporting the means for producing thermal energy relative to the support stand and preventing an unintended lateral shifting of the means for producing away from the smokeless grill kit during the use.

According to another embodiment of the present invention, there is provided a smokeless grilling kit, further comprising: a grill pan holding sub-assembly in the support stand, and the grill pan holding sub-assembly positionably supporting the grill pan member centrally over the means for producing thermal energy, whereby the grill pan sub-assembly prevents an unintended lateral shifting of the grill pan member during the use thereby improving user safety.

According to another embodiment of the present invention, there is provided a smokeless grilling kit, wherein: the means for producing thermal energy further comprises: a burner unit, and the burner unit including sliding means for slidably controlling a combustion in the burner unit during the grilling use, whereby the sliding means enables the user to at least terminate a combustion in the burner unit at an end of the use.

According to another embodiment of the present invention, there is provided a smokeless grilling kit, further comprising: a handle projecting laterally away from a top portion of the burner unit, the top portion defining a central opening allowing an upwardly escape of the thermal energy from a cavity bounded by a bottom portion of the burner unit, the bottom portion separably joined to the top portion of the burner unit, a sliding member slidably positioned in the top portion, and the sliding member including an actuating gripping portion extending relative to the handle enabling a sliding control of the sliding member relative to the top portion, thereby enabling the user to actuate the sliding member relative to the handle and slid the sliding member over the central opening and terminate the combustion at the end of the use.

According to another embodiment of the present invention, there is provided a smokeless grilling assembly, comprising: a grill pan member supporting a removable grill top member, the grill top member including a grilling surface proximate a central region of the grill top member for grilling food items, means for producing thermal energy and for directing the thermal energy upwardly toward the grilling surface, and a support stand member supporting the grill pan member above the means for producing thermal energy and spacing the grill pan member from an external support surface, and means for diverting grilling oils laterally away from a central hotter region of the grilling surface to a cooler peripheral region remote from the central region, whereby the oil is cooled and does not smoke during a grilling use.

According to another embodiment of the present invention, there is provided a smokeless grilling assembly, further comprising: a means for receiving the grilling oils from the means for diverting during the use and storing the oils in a position remote from the central hotter region, whereby the oils are additionally cooled and easily contained during the use enabling convenient user disposal.

According to another embodiment of the present invention, there is provided a smokeless grilling assembly, further comprising: a plurality of embossed portions on the curved grilling surface, whereby the embossed portions space the grilling food items from the grilling surface enabling the grilling oils to be more easily transported laterally from the central hotter region to the cooler peripheral region.

According to another embodiment of the present invention, there is provided a smokeless grilling assembly, further comprising: a plurality of holes spaced about the peripheral region of the grilling surface proximate the means for receiving, whereby a portion of the grilling oils passes through ones of the plurality of holes and falls into the means for receiving.

According to another embodiment of the present invention, there is provided a smokeless grilling assembly, wherein: each hole is positioned proximate respective outward ends of the embossed portions, whereby the embossed portions aid in guiding the grilling oils into holes.

According to another embodiment of the present invention, there is provided a smokeless grilling assembly, wherein the support stand member further comprises: means for centrally locating the means for producing thermal energy relative to the grill pan and the grill top members, whereby during the use the thermal energy is produced proximate the central hotter region of the grill top member.

According to another embodiment of the present invention, there is provided a smokeless grilling assembly, wherein the grill pan member includes a centrally positioned opening between the means for producing thermal energy and the curved grilling surface.

According to another embodiment of the present invention, there is provided a smokeless grilling assembly, further comprising: a grill support member, and the grill support member spanning a portion of the grill pan member and supporting the grill top member relative to the grill pan member, whereby the grill top member is spaced from the grill pan member.

According to another embodiment of the present invention, there is provided a smokeless grilling assembly, further comprising: a non-stick coating on at least one of the curved grilling surface, the grill pan member, and the means for diverting grilling oils, whereby the non-stick coating improves a transport of the grilling oils and eases clean up after the use.

According to another embodiment of the present invention, there is provided a smokeless grilling assembly, further comprising: a burner support sub-assembly in the support stand for positionably supporting the means for producing thermal energy relative to the support stand and preventing an unintended lateral shifting of the means for producing away from the assembly, and a grill pan holding sub assembly in the support stand for positionably supporting the grill pan member centrally over the means for producing thermal energy, whereby the grill pan sub assembly prevents a lateral shifting of the grill pan during the use thereby improving user safety.

According to another embodiment of the present invention, there is provided a smokeless grilling assembly, further comprising: at least one utensil for use in controlling a grilling of the food items.

According to another embodiment of the present invention, there is provided a smokeless grilling assembly, further comprising: at least a support plate member for spacing the support stand member from a support surface, whereby the support plate enables an easy transport of the grill assembly while additionally preventing any thermal transfer from the means for producing thermal energy to the support surface.

According to another embodiment of the present invention, there is provided a smokeless grilling assembly, further comprising: at least one condiment container for containing food items to be grilled, whereby the condiment container enables a safe storage of the food items on the support plate member without a contamination of the support plate member thereby improving the health safety of the grill assembly.

According to another embodiment of the present invention, there is provided a smokeless grilling kit, comprising: a grill pan member supporting a grill top member, the grill top member including a grilling surface for grilling external food items, means for producing thermal energy and for directing the thermal energy upwardly toward the grilling surface, a support stand member supporting the grill pan member above the means for producing thermal energy and spacing the grill pan member from an external support surface, means for diverting grilling oils laterally away from an inner hotter region of the grilling surface to a cooler peripheral region remote from the inner hotter region, whereby the oil is initially cooled and does not smoke during a grilling use, and a means for receiving the grilling oils from the means for diverting during the use and for storing the oils in a position remote from the inner hotter region and the means for producing, whereby the oils are additionally cooled and easily contained during the use enabling a safe and a convenient user disposal.

According to another embodiment of the present invention, there is provided a smokeless grilling kit, further comprising: at least one of a plurality of embossed portions on the grilling surface and a plurality of holes spaced about an outer portion of the grill top member, and the at least one improving a transport of the grilling oils from the inner hotter region to the means for receiving, whereby the smokeless grilling kit rapidly minimizes a temperature of the grilling oils and reduces a risk of smoking.

According to another embodiment of the present invention, there is provided a smokeless grill set, comprising: a grill top having an axially central region and a grilling surface, a grill pan coaxial with central region, a removable grill support in the grill pan supporting the grill top, means for controllably producing thermal energy below the grill top being axially aligned with the central region and the grill pan, grill stand means for supporting the grill pan aligned with the grill top member and the central region, means for diverting dripping oil generated by a grilling of external food items on the grilling surface laterally from the central region to an axially remote cooler peripheral region of the grill top member so that the oil is cooled and does not smoke, means for transferring cooled oil from the grill top to the grill pan, at least one receiving collector, and the receiving collector receiving the cooled oil from the peripheral region for cooled storage during the use to minimize additional heating of the oil and further smoking.

According to another embodiment of the present invention, there is provided a smokeless grill set, further comprising: means for supporting grilled items above a grilling surface of the grill top and allowing easy transport of the tripping oil to the peripheral region.

According to another embodiment of the present invention, there is provided a smokeless grill set, wherein: the means for supporting includes at least one embossed portion on the grill top, whereby the grilled items are supported by or between the at least one embossed portion and partially spaced from the grilling surface thereby allowing easy passage of the dripping oil away from the grilled items to the means for transferring.

According to another embodiment of the present invention, there is provided a smokeless grill set, further comprising: a burner unit support in the grill stand, the burner unit support coaxial to the central axis, and the burner unit support shaped to removably support the burner unit during the use, whereby the burner unit is centrally supported under the grill top and heats the central heated region during the use.

According to another embodiment of the present invention, there is provided a smokeless grill set, further comprising: wherein: the grill stand includes a plurality of bent wire members, at least first sections of the bent wire members supporting the grill pan about a portion of an outer periphery, and at least second sections of the bent wire members forming the burner unit support, whereby the grill stand is simple and cost effective to manufacture.

According to another embodiment of the present invention, there is provided a smokeless grill set, further comprising: a handle on the burner unit, means for controlling a combustion rate of the burner unit, and the means for controlling including a handle actuation mechanism for at least adjusting an air flow to an external burner unit housed in the burner unit, whereby the handle actuation mechanism enables the user to adjust the means for controlling during or after the use thereby improving a grilling experience and a safety of the smokeless grill set.

According to another embodiment of the present invention, there is provided a smokeless grill set, wherein: the handle includes a fixed portion and a slidable portion, the means for controlling including a sliding lid slidably covering central opening in the burner unit, and the slidable portion controllably joined to the sliding lid, whereby a sliding adjustment of the slidable portion relative to the fixed portion adjusts the sliding lid relative to the central opening enabling an adjustment of the air flow.

According to another embodiment of the present invention, there is provided a smokeless grill set, wherein: the means for controlling a combustion rate includes a plurality of air holes spaced about a central opening of the burner unit, and the means for controlling additionally includes a rotational adjustment mechanism on the handle enabling a rotational regulation of the air holes, whereby during a use an adjustment of the rotational adjustment mechanism relative to the handle enables a controlling adjustment of the air holes and a regulation of the combustion rate.

According to another embodiment of the present invention, there is provided a smokeless grill set, wherein: the burner unit further comprises a bounded cavity for receiving an external heating element, and a cover on the burner unit enables a removable covering of a central opening in the burner unit thereby retaining an external heating element therein while allowing passage of the thermal energy from the external heating element through. the central opening.

According to another embodiment of the present invention, there is provided a smokeless grill set, further comprising: a plurality of projecting feet the grill support, and a corresponding plurality of holes in the grill pan for receiving the feet and positioning the grill support in the grill pan and prevent a relative rotation between the grill support and the grill pan during the use.

According to another embodiment of the present invention, there is provided a smokeless grill set, further comprising: a plurality of slots on a bottom rim of the grill top, and each slot fitting over portions of the grill support during the use and preventing a relative rotation between the grill top, and the grill support and the grill pan.

According to another embodiment of the present invention, there is provided a smokeless grill set, further comprising: a central portion of the grill pan defined between the central heated region of the grill top and a top of the means for controllably producing thermal energy, and the central region of the grill pan being at least one of a continuous surface, a central opening, and a divided opening, whereby heat from the means for controllably producing passes upwardly through the central region and heats the central heated region during the use.

According to another embodiment of the present invention, there is provided a smokeless grill set, wherein: the grill top is a concave domed member.

According to another embodiment of the present invention, there is provided a smokeless grill set, wherein: the grill top is a quadrilateral domed member.

According to a further set of features of the present invention, there is provided a smokeless grill assembly, wherein: the grill top is a convex grill top member, and a center of the grill top member is farther from the grill pan along a central axis than the cooler peripheral region.

The above, and other objects, features and advantages of the present invention will become apparent from the following description read in conjunction with the accompanying drawings, in which like reference numerals designate the same elements.

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings of alternative embodiments.

FIG. 1 is a front elevational view of the smokeless grill assembly.

FIG. 2 is top view of the smokeless grill assembly.

FIG. 3 is a top view of the grill pan.

FIG. 4 is a partial sectional side view of the grill pan along section I-I in FIG. 3.

FIG. 5 is a top view of the universal burner unit in the smokeless grill assembly.

FIG. 6 is a side elevational view of the universal burner with a cut-away to show the internal wall profile.

FIG. 6B is a sectional view along line II-II of FIG. 5.

FIG. 7 is a top view of the grill stand.

FIG. 8 is a side elevational view of the grill stand.

FIG. 9 is a top view of the grill top.

FIG. 10 is a partial side elevational view of the grill top with a partial sectional view along line III-III of FIG. 9.

FIG. 11 is a top view of the grill support assembly.

FIG. 12 is a side elevational view of the grill support assembly shown in FIG. 11.

FIG. 13 is a front elevational view of a second embodiment of the smokeless grill assembly.

FIG. 14 is a top view of the second embodiment of the smokeless grill assembly.

FIG. 15. Is a top view of the grill pan in the second embodiment.

FIG. 16 is a partial sectional side view of the second embodiment grill pan along line IV-IV in FIG. 15.

FIG. 17 is a top view of the grill stand in the second embodiment of the smokeless grill assembly.

FIG. 18 is a side elevational view of the second embodiment of the grill stand.

FIG. 19 is a top view of the grill top with shadow lines showing assembly with the grill support.

FIG. 20 is a side elevational view of the second embodiment of the grill tip with a partial sectional view along line V-V in FIG. 19.

FIG. 21 is a top view of the second embodiment of the grill support assembly.

FIG. 22 is a side elevational view of the grill support assembly in FIG. 21.

### DETAILED DESCRIPTION OF THE PREFERRED EMBODIMENT

In addressing the issues noted above, features of the present invention provide a smokeless grill assembly that overcomes at least one of the detriments known from the conventional art.

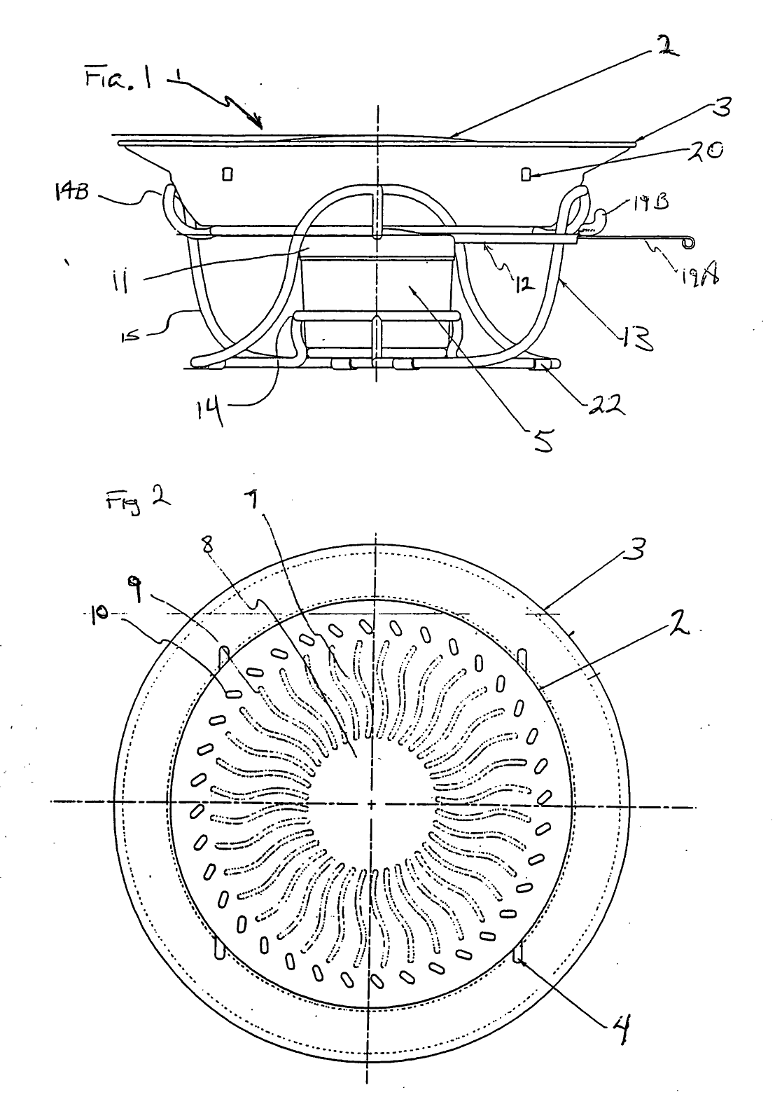

Referring now to FIGS. 1 and 2, a smokeless grill set, kit, or assembly 1 includes a grill pan 3 supporting a grill support 4. A grill top 2 is supported by grill support 4 relative to grill pan 3. A grill stand 13 supports grill pan 3, as shown. As will be discussed in additional detail later, grill stand 13 functions both as a support (as will be described) and as a decorative carrying support including multiple gripping surfaces and positions.

A universal burner unit 5 is positioned under grill pan 3 in a burner unit support portion 14A of grill stand 13. In this embodiment, grill pan 3 and grill top 2 are coaxial along a central axis, but this positioning is an optional element of the present invention. Grill stand 13 includes a plurality of bent wire portions 15 shaped to cradle and support grill pan 3 during use in a grill support portion 14B. Grill support portion 14B is positioned above burner unit support portion 14A thereby allowing a grilling thermal energy to rise upwardly so that food items may be grilled on grill top 2.

A plurality of feet 22 space grill stand 13 and smokeless grill kit 1 from a support surface and provide a slip-resistance with the support surface for increased user safety. In the present embodiment feet 22 are formed from a deformable material capable of elastically gripping the circumference of bottom portions of grill stand 13. It should be understood by those skilled in the art of consumer product design, that feet 22 may be formed from any readily used and available material and may be formed in any reasonable design capable of achieving the spacing and safety functions noted above.

Universal burner unit 5 includes a handle 12 projecting outwardly from a top 11. Handle 12 includes a sliding handle portion 19A extending beyond a middle grip portion 19B. A sliding lid portion (shown later) in top 11 of is guidably fixed to sliding handle portion 19A. During use, a user may move sliding handle portion 19A relative to middle grip portion 19B and slide the lid portion (shown later) to open or close a top opening in top 11, as will be described in detail below.

Feet portions 20 of grill support member 4 extend through holes in grill pan 3 as shown and resist relative rotation between grill pan 3 and grill support 4 during use or transport.

In the present embodiment, grill top 2 includes a heated region 8 positioned generally over universal burner unit 5, and an peripheral cooler region 7; shown in the present embodiment as an axially distant peripheral region 7. While not required for operation, the present embodiment additionally includes embossed portions 9 are arrayed about grill top 2 proximate peripheral region 7 and central region 8. Embossed portions 9 function to slightly space grilling items from complete contact with the grilling surface and additionally serve as an aid in guiding grilling oils away from heated region 8 toward a plurality of holes 10. Holes 10 in grill top 2 are, in this embodiment, spaced about the outer perimeter of grill top 2, as shown, proximate end portions of embossed portions 9. Holes 10 are shaped to receive grilling oils, as will be described.

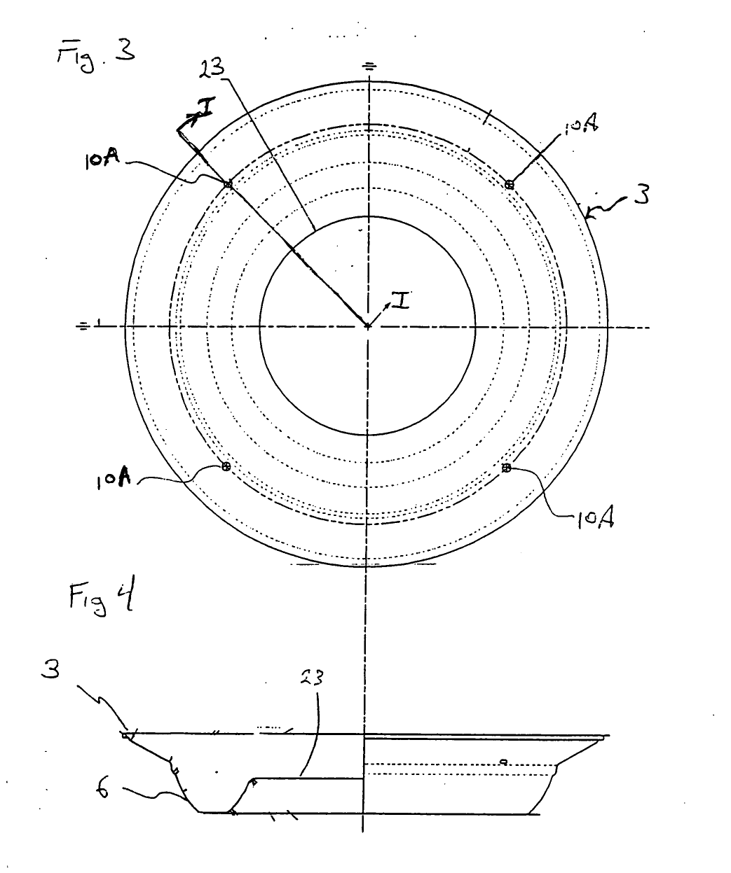

Referring now to FIGS. 3 and 4, grill pan 3 includes a central region 23 and surrounding holes 10A for receiving feet 20 on grill support 4. In the present preferred embodiment, central region 23 is formed as an opening above universal burner unit 5, allowing combustion gasses to rise upwardly and contact an underside of central region 8 for grilling.

Alternative embodiments are envisioned wherein central region 23 is partially or fully closed (both not shown). Where central region 23 is partially closed, addition smaller holes may be included allowing a thermal energy to rise upwardly through a spaced opening. Where central region 23 is partially or fully closed thermal energy rising upwardly will be partially or fully blocked and diverted in some portion. Where central region 23 is fully closed, grilling energy is buffered and reduced, but still transmitted to grill top 2 for grilling. In this manner, the present invention envisions multiple designs for grill pan 3 and central region 23 adaptive to particular user grilling needs or manufacturing requirements.

Since feet 20 extend through holes 10A, grill support 4 cannot rotate relative to grill pan 3. While alternative embodiments for grill support 4 are envisioned, the present design allows assembly 1 to be stabilized and made safer during use and transport.

A receiving collector 6 is formed in grill pan 3 distant from the central region 23, and universal burner unit 5, as shown. While the present embodiment is symmetrical about a central axis, alternative embodiments are envisioned allowing rectangular, ovoid, or other amorphous shapes adaptive to a manufacturer's needs, each including a receiving collector 6 distant from one or a plurality of universal burner units 5.

Side walls of grill pan 3 extend upwardly from receiving collector 6 and extend generally above central region 23 in this preferred embodiment, although this is not required. In this manner, grill pan 3 contains grill support 4 and grill top 2. During use, hot oil from grilled items on grill top 2 roll down the grill surface, through holes 10 and drips into receiving collector 6. In this manner the hot oil is transported outwardly from heated region 8 to the cooler receiving collector 6 without burning or smoking.

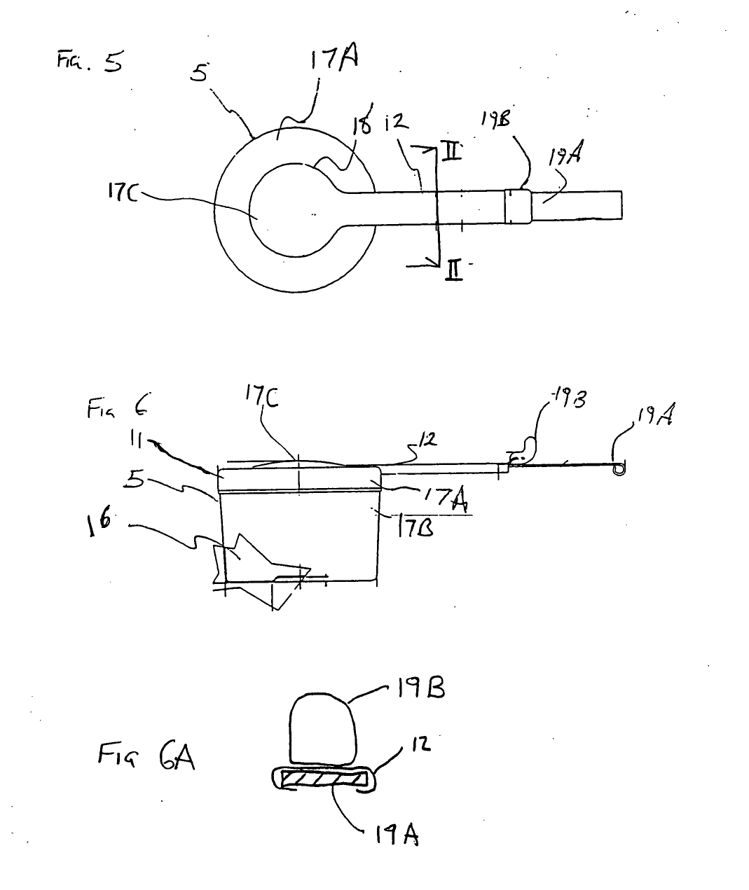

Referring now to FIGS. 5, 6, and 6A, universal burner unit 5 includes top 11 having a cover rim portion 17A. Cover rim portion 17A is mounted on a bottom 17B surrounding and defining a bounded cavity 16. Cover rim 17A defines a cover central opening 18 that allows thermal energy or flame to escape upwardly during grilling.

Top 11 and bottom 17B are releasably joined allowing an external combustion element (not shown) to be placed withing burner unit 5. Top 11 and bottom 17B may be releaseably joined in any suitable manner including a sliding fit, overlap construction, or threaded connection sufficient to minimize combustion air entry to burner unit 5 along the joint there between. One example of a suitable combustion element is a Sterno element containing a gelled petroleum-based product. Alternatively, a candle, or other ignitable items may be positioned within burner unit 5 and adapted to provide a grilling energy to grill pan 2.

Handle 12 extends outwardly from cover rim 17A on top 11. Sliding grip portion 19A is retractable and extendable through handle 12 relative to grip portion 19B. Grip portion 19A extends through grip portion 19B of handle 12 to a cover rim slider 17C removably covering cental opening 18. Grip portion 19A allows a user to slid cover rim slider 17C relative to cover rim 17A and cover central opening 18 to extinguish the upwardly-rising combustion in universal burner unit 5 at the end of a grill use or open opening 18 at a beginning of a use.

The present design enables several mechanisms or means for controlling the combustion rate or temperature of the external fuel canister and thereby improve both the grilling/smokeless features of the present invention and overall user safety. As a first combustion control, a user may adjustably slid cover rim slide 17C partially over opening 18, thereby limiting combustion. As a second combustion control mechanism it is envisioned that a portion of top 11 may adaptively include air access holes spaced about central opening 18 (not shown) and that top 11 and handle 12 include rotation mechanisms for rotating handle 12 relative to top 11 and adjustably opening or closing the air access holes. This type of design for a universal burner unit top is shown within the present assignee's U.S. Pat. No. 6,701,912 issued Mar. 9, 2004, the contents of which are incorporated herein as an explanatory reference regarding these features.

It should be understood, that while cover rim slider 17C and sliding grip portion 19A provide additional convenience and safety to the present embodiment, these elements are not necessary to practice the invention.

Grip portion 19B is typically covered by a thermal resistant substance, such as phenolic resin, to provide a cool grip for a user to lift and remove universal burner unit 5 from beneath grill pan 3 (before, during, or after a use) to replace or extinguish a heat source, as will be explained.

During assembly, an external heat source, such as a canister containing a solid or semi-solid flammable substance (as noted above), is positioned within cavity 16 and top 11 is snapped in place. The heat source is ignited and handle 12 is used to position universal burner unit 5 in burner unit support portions 14.

After assembly, universal burner unit 5 rests within burner unit support 14 between both grill top 2 and grill pan 3 and the support surface. Consequently, heat rising from universal burner unit 5 rises and heats central heated region 8 principally through convection. Cooler peripheral region 7 is warmed through conduction and convection from heated region 8.

Alternative designs are envisioned for the instant invention allowing the easy lateral insertion and removal of burner unit 5 from below grill pan 3, before, during, or after a use (not shown). In this alternative embodiment, grill stand 13 is designed to extend upwardly to allow burner unit 5 to be lifted by handle 12 from burner unit support 14 and laterally transported outwardly from its generally central location for easy replacement of the external fuel container without requiring disassembly of or removal of grill pan 3 from grill stand 13. This alternative embodiment improves a user safety and convenience. This alternative embodiment also envisions easy adaptation to non-circular designs for grill pan 3 and grill top 2, for example, where smokeless grill set 1 is a long rectangular design requiring multiple universal burner units 5 and burner unit support portions 14.

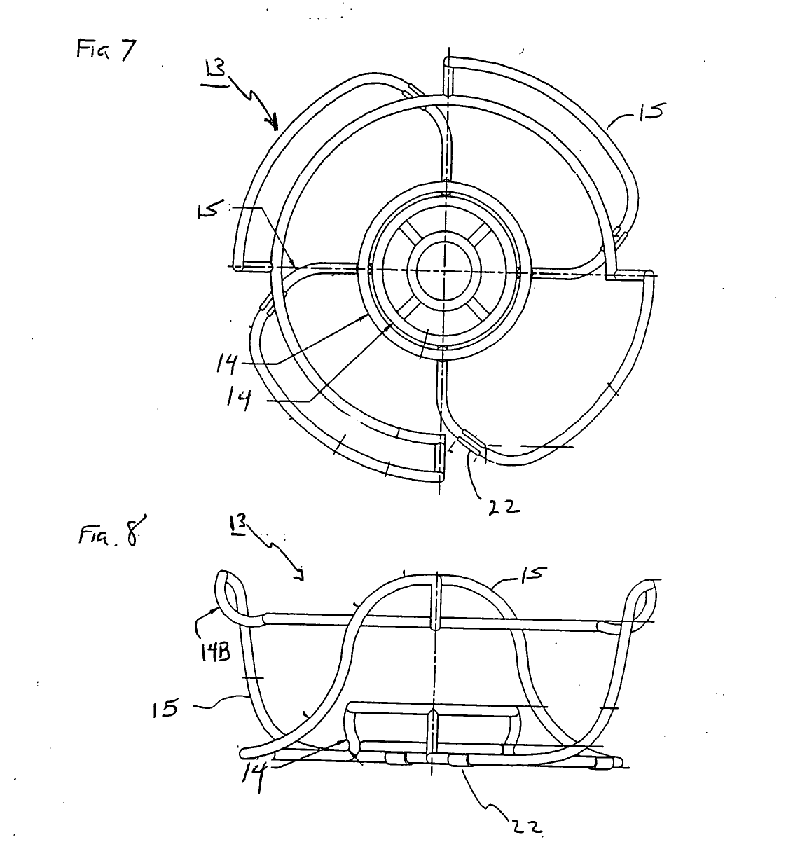

Referring now to FIGS. 7 and 8, grill stand 13 includes a plurality of bent wire members 15 as shown. Wire members 15 are bent into the forms shown and secured to each other generally by welding. Those skilled in the art will recognize that there are additional ways to secure wire members 15 to each other in addition to those stated, for example by using glue or connectors. Those skilled in the art will also recognize that wire members 15 and grill stand 13 may be formed from alternative materials (aluminum, copper etc.) and in alternative manners (stamped steel or sheet metal) without going beyond the scope and spirit of the present invention.

Wire members 15 are shaped to form burner unit support 14 in a central region generally coaxial to the central axis of grill top 2 and grill pan 3. Wire members 15 are also shaped to form grill support portion 14B, as shown. It should be understood by those skilled in the art that wire members 15 of burner unit support 14 and grill support portion 14B allow sufficient clearance between respective burner units 5 and grill pans 3, to allow easy removal of the same while providing a securing boundary eliminating dangerous lateral shifting and displacement. As additionally noted above, wire members 15 are shaped in a pleasing design providing functional support and multiple positions for grasping grill stand 13 for easy transport, without endangering a user. Alternative embodiments are envisioned for grill stand 13, where wire members 15 additionally include specific handle portions (not shown) projecting outwardly enabling a convenient and safe position for carrying smokeless grill assembly 1.

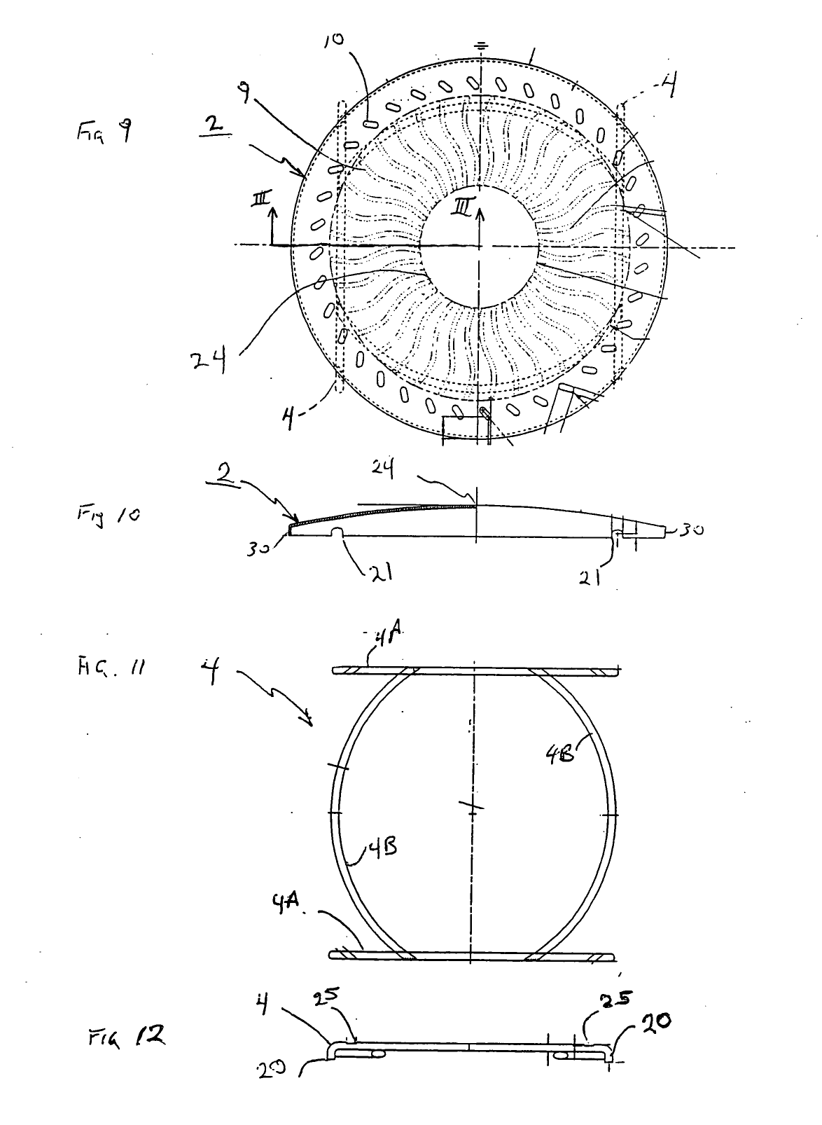

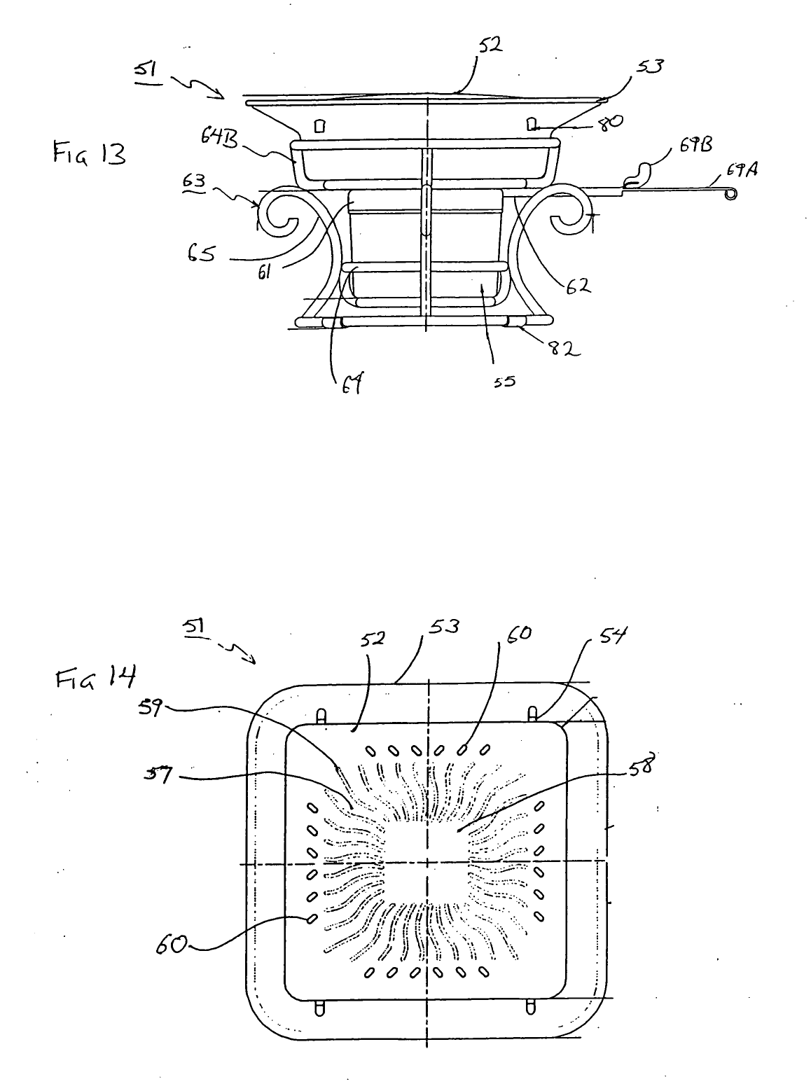

As noted above, feet 22 are typically plastic or elastomeric members extending from and partially surrounding bottoms of wire members 15 along straight sections to space grill stand 13 from a work surface. Feet 22 are shown preferably as semi-cylinders for simplicity of manufacture, but many other types of feet are capable of substitution without departing from the scope and spirit of the present invention Referring now to FIGS. 9 through 12, grill top 2 includes a heated region 24 generally proximate heated region 8 in grill pan 3. In the present embodiment heated region is coaxial to heated region 8 and grill assembly 1 as shown.

In one alternative embodiment, where central region 23 is a solid region spanning sides of receiving collector 6, heat is passed by convection from universal burner unit 5, heating central region 23 which in turn passes heat through convection to central heated region 8. In an alternative embodiment, where central region 23 is an opening or a space (divided or clear) bounded by receiving collector 6, heat passes directly upwardly from universal burner unit 5 to central heated region 8, and then flows laterally outwardly along the inner bottom surface of grill top 2 to escape outwardly along the gap between grill top 2 and grill pan 3. In either embodiment, there is sufficient thermal transfer to central heated region 8 from universal burner unit 5 to grill or warm items on the top surface of grill top 2.

Grill support 4 includes a plurality of wires, including two opposing leg wires 4A, 4A and two bent spanning wires 4B, 4B. Spanning wires 4B join respective leg wires 4A. Feet 20 extend from ends of leg wires 4A for engagement with and insertion through holes 10A in grill pan 3.

Flat sections 25 adjacent ends of each respective leg wire 4A engage respective slots 21 formed in an outer rim of grill top 2. Through the interaction of flat sections 25 and slots 21, grill top 2 is prevented from rotation relative to grill support 4 and is positionally retained in grill pan 3.

The outer rim 30 of grill top 2 is smoothly turned downwardly, away from the grill surface and a central point 24 of grill top 2. Grill top 2 is formed in a partial convex or sloped manner, as shown and may be circular, quadrilateral (4-sided) or amorphous shape, in any form effective to achieve the spirit and scope of the present invention.

The outer perimeter (in this embodiment a diameter) of grill top 2 is less than the inner perimeter of grill pan 3, proximate the outer edge of receiving collector channel 6. Consequently, employing the present design as a smoke control mechanism or means, as hot oil from grilled items on grill top 2 runs outwardly along embossed portions 9 and through holes 10, any additional or missed oil continues outwardly, beyond holes 10, and slides over outer rim 30 to drip into grill pan 3 and into receiving collector 6.

Oils commonly used for grilling include, canola oil, sunflower/safflower seed oil, walnut oil, olive oil (all types), and many others known to those skilled in the oil-based grilling arts. It should be understood, that since receiving collector 6 is not directly heated, the temperature of oil received in receiving collector 6 will remain below a smoke or burn point of a particular oil or combination of oils. As a result, the present invention prevents smoke and burning during the grilling process.

While various cooking oils (for example, walnut oil) have a very low smoke point, other oils cover a broad span of smoke points (low to high). Obviously, where an oil having a high smoke point is used, a higher grilling heat can be used. Where an oil having a particularly low smoke point is used, the grilling heat may need to be adjusted using the combustion/temperature control mechanisms noted above to avoid oil smoking.

As an additional smoke control mechanism, a volume of water may be placed within receiving collector 6 to cool the oil (water having an evaporation point below the smoke point of most oils) if the oil has not sufficient cooled by sliding over cooler peripheral region 7, to prevent smoking, and to ease cleaning after use.

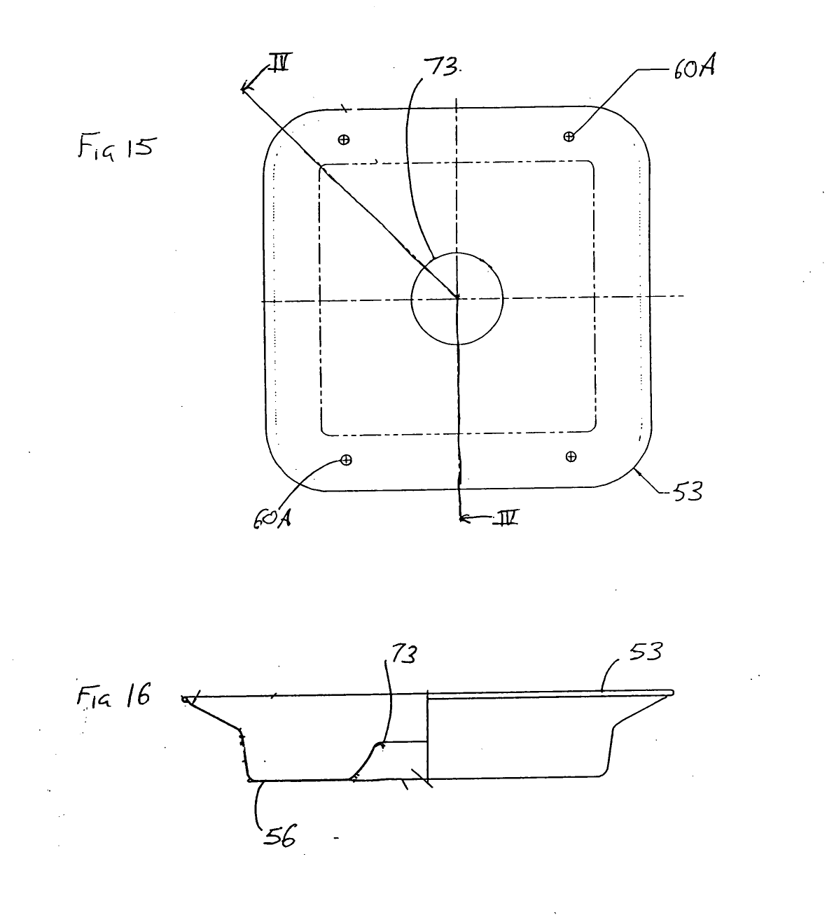

Referring now to FIGS. 13 and 14, a second embodiment of the present invention is shown as a smokeless grill set, assembly, or kit 51 including a grill pan 53 supporting a grill support 54. A grill top 52 is supported by grill support 54. A grill stand 63 supports grill pan 53, as shown. A universal burner unit 55 is positioned under grill pan 53 in a burner unit support portion 64 of grill stand 63. Universal burner unit 55 is constructed in a similar manner to universal burner unit 5 and additional discussion is therefore not provided.

Grill pan 53 and grill top 52 are positioned relative to each other and are generally shaped in a rounded-square or pseudo-rectangular form although any rectilinear or any other shape may be provided and easily adapting according to the scope and spirit of the present invention Gill stand 63 includes a plurality of bent wire portions 65 shaped to cradle and support grill pan 53 in a grill support portion 64B during a use or a transport.

Universal burner unit 55 includes a handle 62 projecting from a top 61. Handle 62 includes a sliding handle portion 69A extending beyond a middle grip portion 69B. Feet 80 of grill support 54 extend through holes in grill pan 53 and resist relative rotation between grill pan 53 and grill support 54 during use.

Grill top 52 includes a central heated region 58 positioned over universal burner unit 55, and an distant cooler peripheral region 77. Embossed portions 59 are arrayed about grill top 52 proximate peripheral region 57. Holes 60 in grill top 52 are spaced about the outer perimeter of grill top 52 as shown.

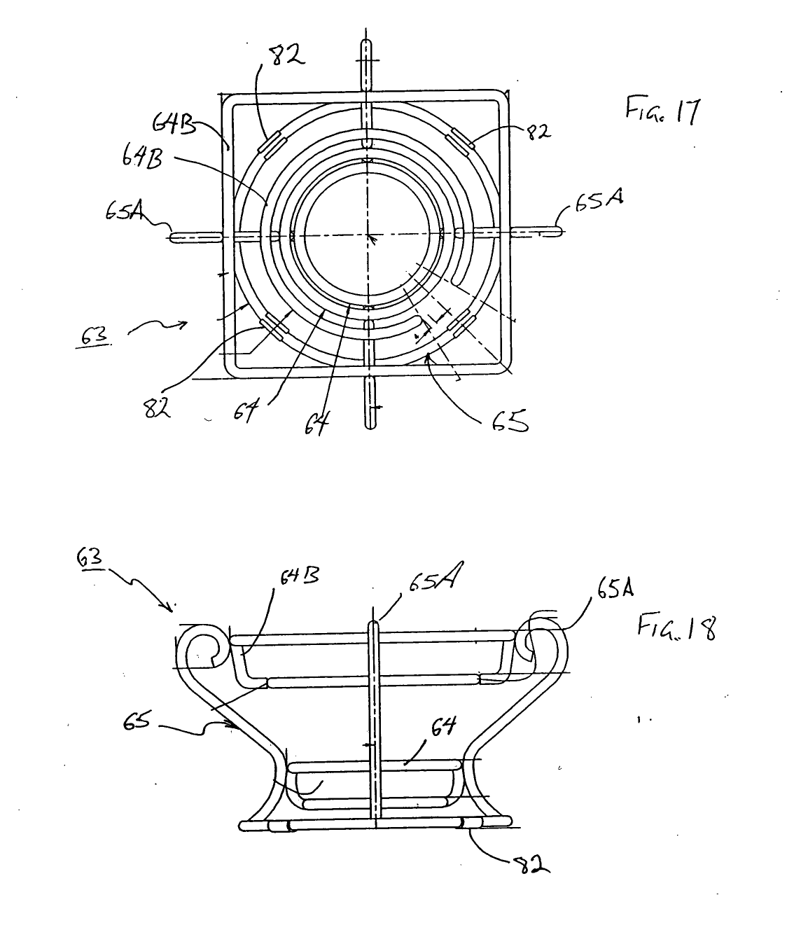

Referring now to FIGS. 15 and 16, similar to the embodiment noted above, a grill pan 53 includes a central region 73 and surrounding holes 60A for receiving feet 80 on grill support 54, as will described. Since feet 80 extend through holes 60A, grill support 54 cannot rotate relative to grill pan 53 and assembly 51 is stabilized and made safer.

A receiving collector portion 56 is formed in grill pan 53 positioned distant from central region 73. Side walls of grill pan 53 extend upward from receiving collector 56 and extend above central region 73. In this manner, grill pan 53 contains and supports grill support 54 and grill top 52.

During use, hot oil from grilled items on grill top 52 roll down the sloped grill surface, through holes 60 and falls into receiving collector 56. In this manner the hot oil is removed from central heated region 58 to receiving collector 66 without burning.

After assembly, universal burner unit 55 rests within burner unit support portion 64 below both grill top 52 and grill pan 53. Consequently, heat rising from universal burner unit 55 rises and heats central heated region 58 principally through convection. Cooler peripheral region 57 is warmed principally through conduction from central heated region 58 and also through convection of thermal energy transferring across the bottom surface of grill top 52.

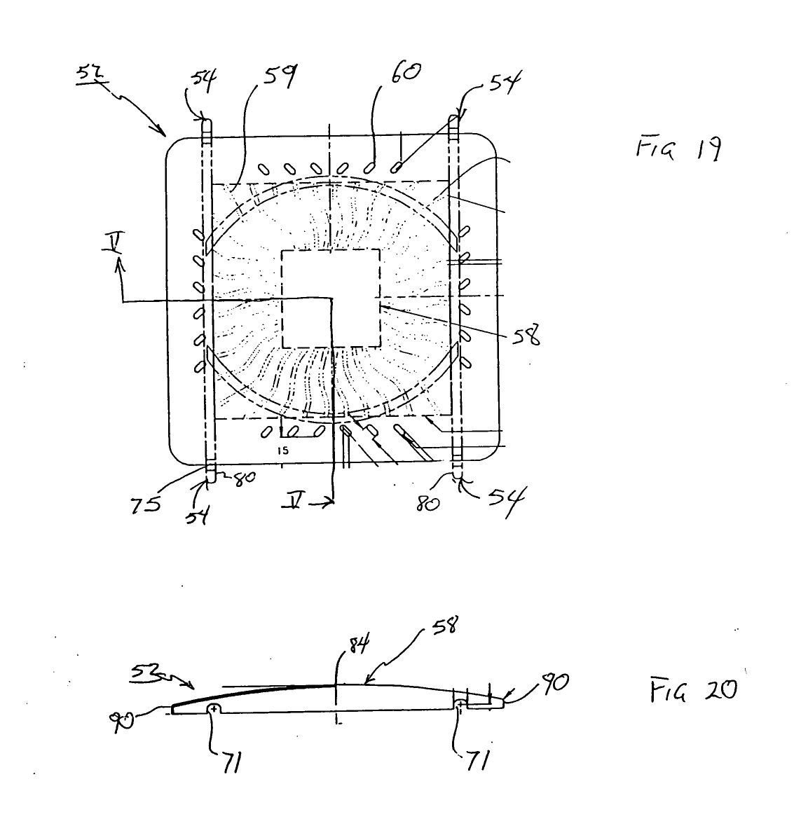

Referring now to FIGS. 17 and 18, grill stand 63 includes a plurality of bent wire members 65 as shown. Wire members 65 are bent into the forms shown and secured to each other generally by welding. Those skilled in the art will recognize that there are additional ways to secure wire members 65 to each other in addition to those stated, for example by using glue or connectors.

Wire members 65 are shaped to form burner unit support 64 in a region generally below grill top 52 and grill pan 53. Wire members 65 also form grill support portion 64B for supporting grill pan 53. Feet 82 are plastic or elastomeric members extending from bottoms of wire members 65 along straight sections to space grill stand 63 from a work surface. Feet 82 are shown preferably as semi-cylinders for simplicity of manufacture, but many other types of feet are capable of substitution without departing from the scope and spirit of the present invention.

As noted above in the previous embodiment, wire members 65 may additionally include handle portions, shown here as handle portions65A projecting outward from grill stand 63 enabling easy holding and transport of smokeless grill assembly 1. Those skilled in the art of consumer product design will recognize that many alternative designs may be created for grill stand 63 without departing from the scope, spirit, and function of the instant invention. Accordingly, it will be understood, that the handles 65A may be removed, moved, repositioned, or redesigned without departing from the instant invention.

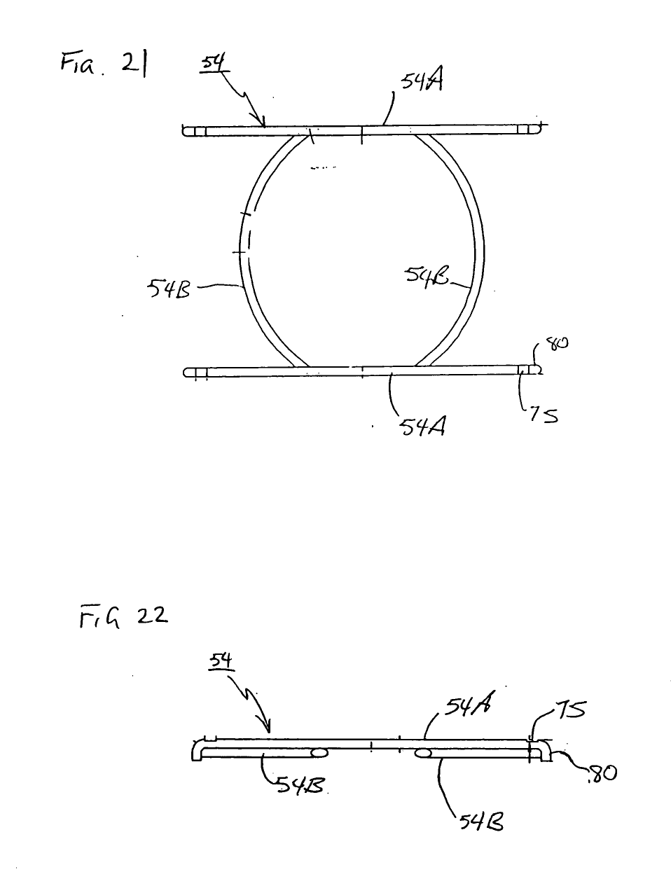

Referring now to FIGS. 19 through 22, grill top 52 includes central heated region 58 positioned above central region 73 in grill pan 53. As noted earlier, where central region 73 is designed as solid region spanning sides of receiving collector 56, heat is passed from universal burner unit 55, heating central region 73 which in turn passes heat through convection to central heated region 58. In an alternative embodiment, where central region 73 is an opening or space bounded by receiving collector 56, heat passes directly from universal burner unit 55 to central heated region 58. In either embodiment, there is sufficient heat transmitted to central heated region 58 from universal burner unit 55 to grill items on the top surface of grill top 52.

Grill support 54 includes a plurality of wires, including two opposing leg wires 54A, 54A and two bent spanning wires 54B, 54B, although those skilled in the art will recognize that alternative designs that many other designs are possible using single piece grill supports 54, or removing grill support 54 all together and providing projecting leg portions on an outer rim of grill top 52 that contact the inner surface of grill pan 53.

Spanning wires 54B join respective leg wires 54A. Feet 80 extend perpendicular from ends of leg wires 54A, as shown for insertion through holes 60A in grill pan 3, although other designs for feet 80 are envisioned for alternative designs complementing the same function.

Flat sections 75, adjacent ends of each respective leg wire 54A, receive respective slot 71 formed in an outer rim 90 of grill top 52. Through the interaction of flat sections 75 and slots 71, grill top 5 is prevented from rotation relative to grill support 4 and is safely retained proximate grill pan 53.

As noted earlier, the outer rim 90 of grill top 52 is turned downward from the grill surface and a central point 84 of grill top 2. The outer diameter of grill top 52 is less than the inner diameter of grill pan 53 proximate receiving collector 56, as shown. Consequently, as hot oil from cooking items on grill top 52 runs along embossed portions 59 through holes 60, any additional or missed hot oil can continue passed holes 60 and slides over outer rim 90 to drip into grill pan 53 and roll into receiving collector 56.

As discussed earlier, in use, a small amount of water or other liquid may be placed within receiving collector 56 to ease cleaning after use, and aid in cooling the hot oil to a lower temperature if the oil has not sufficient cooled down by sliding over cooler peripheral region 57.

An alternative embodiments may additionally provide a non-stick, or high surface tension (high wetting angle) coating on at east one of grill tops 2, 52, grill pans 3, 53, and grill supports 4, 54. In this manner, after use, the elements of smokeless grill kits 1, 51 are easily cleaned by hand or in an automatic washer.

Another alternative embodiment envisions replacing grill tops 2, 52 with removable divided grilling members (not shown) allowing users to grill marsh-mellow's or other soft items above the open flame provided by universal burner units 5, 55. An alternative to this embodiment enables a user to remove grill tops 2, 52 completely and grill over an open flame, where desired by a consumer.

Another alternative design opens central heated regions 8, 58 to allow vertical escape of combustion heat and thereby adapts the present embodiments shown to grilling about the outer periphery of the now-open heated region. This design maintains the smokeless concepts provided here and enables an effective removal of combustion gasses from below grill tops 2, 52.

In yet another alternative embodiment of the present invention, aromatic materials are positioned within receiving collectors 6, 56 and warmed by burner units 5, 55 during use. As the aromatic materials warm they release a desirable scent providing a pleasant grilling experience without generating smoke.

In another alternative embodiment, smokeless grill sets 1, 51 additionally include utensils (not shown) for positioning items to be grilled (described above in U.S. Pat. No. 6,701,912 issued Mar. 9,2004 and incorporated herein by reference). Additional food item or condiment containers (not shown) may be provided in an assembly with grill sets 1, 51 improving a user convenience. In another alternative embodiment, an additional support plate member (not shown) may additionally space grill stands 13, 63 from a support surface for improved safety and ease of transport while including depressions for receiving the utensils, food items, or condiment containers (all not shown). In yet a further embodiment, the support plate member includes a rotational mechanism allowing a user to rotate grill sets 1, 51 and the support plate relative to the support surface.

An additional point should be noted by those skilled in the art wherein holes 10A, 60A (in grill pans 3, 53,) about the outer periphery are distal or spaced away or remote from the hotter inner region of the grilling surface, as shown in the drawings. While alternative embodiments noted above may include an additional central opening, or several smaller central openings, in central heated regions 8, 58 allowing combustion gasses to escape, grilling oils should not pass through any centrally located openings (since these would fall into burner units 5, 55) and should laterally transfer along the sloped grilling surfaces to the outer periphery to pass through holes 10A, 60A. In this manner, it should be understood that holes 10A, 60A are distal or remote from the central region as a beneficial element of the instant design.

In the claims, any means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt=s head and nut compress opposite sides of at least one wooden part, in the environment of fastening wooden parts, a nail, a screw, and a bolt may be readily understood by those skilled in the art as equivalent structures performing equivalent functions.

The preceding description has been presented with reference to the presently preferred features of the invention. Workers skilled in the art and technology to which this invention pertains will appreciate that alterations and changes in the described structure may be practiced without meaningfully departing from the principal, spirit, and scope of this invention. Accordingly, the foregoing description should not be read as pertaining to the precise structures described and illustrated in the accompanying drawings, but rather should be read consistent with and as support to the following claims that are to have their fullest and fair scope.

1. A smokeless grilling kit, comprising:
a grill pan member supporting a removable grill top member;
said grill top member including a grilling surface for grilling external food items;
means for producing thermal energy and for directing said thermal energy upwardly toward said grilling surface;
a support stand member supporting said grill pan member above said means for producing thermal energy and spacing said grill pan member from an external support surface; and
means for diverting grilling oils laterally away from an inner hotter region of said grilling surface to a cooler peripheral region remote from said inner hotter region, whereby said oil is cooled and does not smoke during a grilling use.

2. A smokeless grilling kit, according to claim 1, further comprising:
a means for receiving said grilling oils from said means for diverting during said use and for storing said oils in a position remote from said inner hotter region, whereby said oils are additionally cooled and easily contained during said use enabling a safe and a convenient user disposal.

3. A smokeless grilling kit, according to claim 2, further comprising:
a plurality of embossed portions on said grilling surface; and
said embossed portions spacing portions of said grilling food items from said grilling surface, thereby enabling said grilling oils to be more easily diverted laterally from said inner hotter region to said cooler peripheral region by said means for diverting.

4. A smokeless grilling kit, according to claim 3, further comprising:
a plurality of holes spaced about said grill top member.

5. A smokeless grilling kit, according to claim 4, wherein:
said plurality of holes are spaced about said peripheral region of said grilling surface distal from said hotter inner region, whereby said holes enable portions of said grilling oils to pass through ones of said plurality of holes and fall into said means for receiving.

6. A smokeless grill kit, according to claim 4, wherein:
each said hole is positioned proximate respective outward ends of said embossed portions, whereby said embossed portions aid in guiding said grilling oils into holes.

7. A smokeless grill kit, according to claim 2, wherein:
said support stand member further comprises:
means for centrally locating said means for producing thermal energy relative to said grill pan member and grill top members, whereby during said use said thermal energy is produced proximate said central hotter region of said grill top member.

8. A smokeless grill kit, according to claim 1, wherein:
said grill pan member includes a centrally positioned opening between said means for producing thermal energy and said grilling surface.

9. A smokeless grill kit, according to claim 1, further comprising:
a grill support member; and
said grill support member spanning a portion of said grill pan member and supporting said grill top member relative to said grill pan member, whereby said grill top member is spaced from said grill pan member.

10. A smokeless grill kit, according to claim 1, further comprising:
a non-stick coating on at least one of said grilling surface, said grill pan member, and said means for diverting grilling oils, whereby said non-stick coating improves a transport of said grilling oils during said use and eases clean up after said use.

11. A smokeless grill kit, according to claim 1, further comprising:
a burner support sub-assembly in said support stand; and
said burner support sub-assembly positionably supporting said means for producing thermal energy relative to said support stand and preventing an unintended lateral shifting of said means for producing away from said smokeless grill kit during said use.

12. A smokeless grill kit, according to claim 11, further comprising:
a grill pan holding sub-assembly in said support stand; and
said grill pan holding sub-assembly positionably supporting said grill pan member centrally over said means for producing thermal energy, whereby said grill pan sub-assembly prevents an unintended lateral shifting of said grill pan member during said use thereby improving user safety.

13. A smokeless grill kit, according to claim 1, wherein:
said means for producing thermal energy further comprises:
a burner unit; and
said burner unit including sliding means for slidably controlling a combustion in said burner unit during said grilling use, whereby said sliding means enables said user to at least terminate a combustion in said burner unit at an end of said use.

14. A smokeless grill kit, according to claim 13, further comprising:
a handle projecting laterally away from a top portion of said burner unit;
said top portion defining a central opening allowing an upwardly escape of said thermal energy from a cavity bounded by a bottom portion of said burner unit;
said bottom portion separably joined to said top portion of said burner unit;
a sliding member slidably positioned in said top portion; and
said sliding member including an actuating gripping portion extending relative to said handle enabling a sliding control of said sliding member relative to said top portion, thereby enabling said user to actuate said sliding member relative to said handle and slid said sliding member over said central opening and terminate said combustion at said end of said use.

15. A smokeless grilling assembly, comprising:
a grill pan member supporting a removable grill top member;
said grill top member including a grilling surface proximate a central region of said grill top member for grilling food items;
means for producing thermal energy and for directing said thermal energy upwardly toward said grilling surface; and
a support stand member supporting said grill pan member above said means for producing thermal energy and spacing said grill pan member from an external support surface; and
means for diverting grilling oils laterally away from a central hotter region of said grilling surface to a cooler peripheral region remote from said central region, whereby said oil is cooled and does not smoke during a grilling use.

16. A smokeless grilling assembly, according to claim 15, further comprising:
a means for receiving said grilling oils from said means for diverting during said use and storing said oils in a position remote from said central hotter region, whereby said oils are additionally cooled and easily contained during said use enabling convenient user disposal.

17. A smokeless grilling assembly, according to claim 16, further comprising:
a plurality of embossed portions on said curved grilling surface, whereby said embossed portions space said grilling food items from said grilling surface enabling said grilling oils to be more easily transported laterally from said central hotter region to said cooler peripheral region.

18. A smokeless grilling assembly, according to claim 17, further comprising:
a plurality of holes spaced about said peripheral region of said grilling surface proximate said means for receiving, whereby a portion of said grilling oils passes through ones of said plurality of holes and falls into said means for receiving.

19. A smokeless grill assembly, according to claim 18, wherein:
each said hole is positioned proximate respective outward ends of said embossed portions, whereby said embossed portions aid in guiding said grilling oils into holes.

20. A smokeless grill assembly, according to claim 16, wherein:
said support stand member further comprises:
means for centrally locating said means for producing thermal energy relative to said grill pan and said grill top members, whereby during said use said thermal energy is produced proximate said central hotter region of said grill top member.

21. A smokeless grill assembly, according to claim 15, wherein:
said grill pan member includes a centrally positioned opening between said means for producing thermal energy and said curved grilling surface.

22. A smokeless grill assembly, according to claim 15, further comprising:
a grill support member; and
said grill support member spanning a portion of said grill pan member and supporting said grill top member relative to said grill pan member, whereby said grill top member is spaced from said grill pan member.

23. A smokeless grill assembly, according to claim 15, further comprising:
a non-stick coating on at least one of said curved grilling surface, said grill pan member, and said means for diverting grilling oils, whereby said non-stick coating improves a transport of said grilling oils and eases clean up after said use.

24. A smokeless grill assembly, according to claim 15, further comprising:
a burner support sub-assembly in said support stand for positionably supporting said means for producing thermal energy relative to said support stand and preventing an unintended lateral shifting of said means for producing away from said assembly; and
a grill pan holding sub assembly in said support stand for positionably supporting said grill pan member centrally over said means for producing thermal energy, whereby said grill pan sub assembly prevents a lateral shifting of said grill pan during said use thereby improving user safety.

25. A smokeless grill assembly, according to claim .15, further comprising:
at least one utensil for use in controlling a grilling of said food items.

26. A smokeless grill assembly, according to claim 15, further comprising:
at least a support plate member for spacing said support stand member from a support surface, whereby said support plate enables an easy transport of said grill assembly while additionally preventing any thermal transfer from said means for producing thermal energy to said support surface.

27. A smokeless grill assembly, according to claim 26, further comprising:
at least one condiment container for containing food items to be grilled, whereby said condiment container enables a safe storage of said food items on said support plate member without a contamination of said support plate member thereby improving the health safety of said grill assembly.

28. A smokeless grilling kit, comprising:
a grill pan member supporting a grill top member;
said grill top member including a grilling surface for grilling external food items;
means for producing thermal energy and for directing said thermal energy upwardly toward said grilling surface;
a support stand member supporting said grill pan member above said means for producing thermal energy and spacing said grill pan member from an external support surface;
means for diverting grilling oils laterally away from an inner hotter region of said grilling surface to a cooler peripheral region remote from said inner hotter region, whereby said oil is initially cooled and does not smoke during a grilling use; and
a means for receiving said grilling oils from said means for diverting during said use and for storing said oils in a position remote from said inner hotter region and said means for producing, whereby said oils are additionally cooled and easily contained during said use enabling a safe and a convenient user disposal.

29. A smokeless grilling kit, according to claim 28, further comprising:
at least one of a plurality of embossed portions on said grilling surface and a plurality of holes spaced about an outer portion of said grill top member; and
said at least one improving a transport of said grilling oils from said inner hotter region to said means for receiving, whereby said smokeless grilling kit rapidly minimizes a temperature of said grilling oils and reduces a risk of smoking.

30. A smokeless grill set, comprising:
a grill top having an axially central region and a grilling surface;
a grill pan coaxial with central region;
a removable grill support in said grill pan supporting said grill top;
means for controllably producing thermal energy below said grill top being axially aligned with said central region and said grill pan;
grill stand means for supporting said grill pan aligned with said grill top member and said central region;
means for diverting dripping oil generated by a grilling of external food items on said grilling surface laterally from said central region to an axially remote cooler peripheral region of said grill top member so that said oil is cooled and does not smoke;
means for transferring cooled oil from said grill top to said grill pan;
at least one receiving collector; and
said receiving collector receiving said cooled oil from said peripheral region for cooled storage during said use to minimize additional heating of said oil and further smoking.

31. A smokeless grill set, according to claim 30, further comprising:
means for supporting grilled items above a grilling surface of said grill top and allowing easy transport of said tripping oil to said peripheral region.

32. A smokeless grill set, according to claim 31, wherein:
said means for supporting includes at least one embossed portion on said grill top, whereby said grilled items are supported by or between said at least one embossed portion and partially spaced from said grilling surface thereby allowing easy passage of said dripping oil away from said grilled items to said means for transferring.

33. A smokeless grill set, according to claim 32, further comprising:
a burner unit support in said grill stand;
said burner unit support coaxial to said central axis; and
said burner unit support shaped to removably support said burner unit during said use, whereby said burner unit is centrally supported under said grill top and heats said central heated region during said use.

34. A smokeless grill set, according to claim 33, wherein:
said grill stand includes a plurality of bent wire members;
at least first sections of said bent wire members supporting said grill pan about a portion of an outer periphery; and
at least second sections of said bent wire members forming said burner unit support, whereby said grill stand is simple and cost effective to manufacture.

35. A smokeless grill set, according to claim 34, further comprising:
a handle on said burner unit;
means for controlling a combustion rate of said burner unit; and
said means for controlling including a handle actuation mechanism for at least adjusting an air flow to an external burner unit housed in said burner unit, whereby said handle actuation mechanism enables said user to adjust said means for controlling during or after said use thereby improving a grilling experience and a safety of said smokeless grill set.

36. A smokeless grill set, according to claim 35, wherein:
said handle includes a fixed portion and a slidable portion;
said means for controlling including a sliding lid slidably covering central opening in said burner unit; and
said slidable portion controllably joined to said sliding lid, whereby a sliding adjustment of said slidable portion relative to said fixed portion adjusts said sliding lid relative to said central opening enabling an adjustment of said air flow.

37. A smokeless grill set, according to claim 35, wherein:
said means for controlling a combustion rate includes a plurality of air holes spaced about a central opening of said burner unit; and
said means for controlling additionally includes a rotational adjustment mechanism on said handle enabling a rotational regulation of said air holes; whereby during a use an adjustment of said rotational adjustment mechanism relative to said handle enables a controlling adjustment of said air holes and a regulation of said combustion rate.

38. A smokeless grill set, according to claim 35, wherein:
said burner unit further comprises a bounded cavity for receiving an external heating element; and
a cover on said burner unit enables a removable covering of a central opening in said burner unit thereby retaining an external heating element therein while allowing passage of said thermal energy from said external heating element through said central opening.

39. A smokeless grill set, according to claim 30, further comprising:
a plurality of projecting feet said grill support; and
a corresponding plurality of holes in said grill pan for receiving said feet and positioning said grill support in said grill pan and prevent a relative rotation between said grill support and said grill pan during said use.

40. A smokeless grill set, according to claim 39, further comprising:
a plurality of slots on a bottom rim of said grill top; and
each said slot fitting over portions of said grill support during said use and preventing a relative rotation between said grill top, and said grill support and said grill pan.

41. A smokeless grill set, according to claim 30, further comprising:
a central portion of said grill pan defined between said central heated region of said grill top and a top of said means for controllably producing thermal energy; and
said central region of said grill pan being at least one of a continuous surface, a central opening, and a divided opening, whereby heat from said means for controllably producing passes upwardly through said central region and heats said central heated region during said use.

42. A smokeless grill set, according to claim 30, wherein:
said grill top is a concave domed member.

43. A smokeless grill set, according to claim 30, wherein:
said grill top is a quadrilateral domed member.
